(19) United States
(12) Patent Application Publication
(10) Pub. No.: US 2011/0070020 A1
(43) Pub. Date: Mar. 24, 2011

(54) Heavy-Duty Drive Tube Coupling

(76) Inventor: Charles P. Tabler, Cincinnati, OH (US)

(21) Appl. No.: 12/885,909

(22) Filed: Sep. 20, 2010

Related U.S. Application Data
(60) Provisional application No. 61/244,662, filed on Sep. 22, 2009.

(51) Int. Cl. F16B 7/00

(52) U.S. Cl. 403/359.1

(57) ABSTRACT

A coupling is provided that comprises a base portion and an elongated portion. The elongated portion extends from the face of the base portion. The elongated portion further comprises at least one rib extending from the face of the base portion toward the distal end of the elongated portion. In some embodiments, the at least one rib further comprises at least one detent. In one embodiment, the elongated portion comprises a substantially square cross-section and four ribs evenly-spaced about the perimeter of the elongated portion. The elongated portion, including the ribs and any detents may be sized and shaped to provide a friction fit between the coupling and a drive tube when the elongated portion is inserted into the drive tube. In some embodiments, the base portion and the elongated portion may comprise a single, integral member.

### PRIORITY

This application claims priority to U.S. Provisional Patent Application Ser. No. 61/244,662, filed Sep. 22, 2009, entitled “Heavy-Duty Drive Tube Coupling,” the disclosure of which is incorporated by reference herein.

### BACKGROUND

In a factory or distribution warehouse, it may be desirable to move loads along a transporting path that is predominately horizontal, but which may also involve travel uphill, downhill, diversion between subpaths, and the like. Overhead conveyor systems allow such movement. The systems may comprise rotating drive tubes, a carriage that is supported by the drive tube or a fixed support rail, and a carriage that has skewed drive wheels to engage with the rotating drive tube. The engagement of the skewed wheels with the rotating drive tube propels the carriage along the rotating drive tube or along a fixed rail.

In some conveyor systems, many drive tubes may be used. When multiple drive tubes are used, it may be necessary to connect several drive tubes in succession. Typical devices and methods of connecting drive tubes may be costly and cumbersome as they may require numerous parts. As a result a more reliable way of connecting drive tubes may be desired.

While a variety of coupling devices have been made and used, it is believed that no one prior to the inventor has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is a front view of a prior art drive tube coupling assembly.

FIG. 2 is a top view of the prior art drive tube coupling assembly of FIG. 1.

FIG. 3 is a front view of a prior art washer.

FIG. 4 is a cross-sectional view of the prior art washer of FIG. 3 taken along line 4-4.

FIG. 5 is a perspective view of an exemplary drive tube coupling.

FIG. 6 is a front view of the drive tube coupling of FIG. 5.

FIG. 7 is a side view of the drive tube coupling of FIG. 5.

FIG. 8 is a front view of the drive tube coupling of FIG. 5 within an exemplary drive tube.

FIG. 9 is a front view of the drive tube of FIG. 8.

FIG. 10 is a top view of an exemplary drive tube coupling assembly including two of the drive tube coupling of FIG. 5.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples should not be used to limit the scope of the present invention. Other features, aspects, and advantages of the versions disclosed herein will become apparent to those skilled in the art from the following description, which is by way of illustration, one of the best modes contemplated for carrying out the invention. As will be realized, the versions described herein are capable of other different and obvious aspects, all without departing from the invention. Accordingly, the drawings and descriptions should be regarded as illustrative in nature and not restrictive.

Embodiments of the present drive tube coupling may be used in heavy duty conveyor systems, particularly overhead conveyor systems comprising a carriage suspended therefrom and a rotating drive tube configured to drive the carriage along the overhead conveyor system. Of course, other suitable uses for various embodiments will be apparent to those of ordinary skill in the art based on the teachings herein. By way of example only, embodiments of the present drive tube coupling may be used in overhead conveyors of the type disclosed in U.S. Pat. No. 5,806,655 issued Sep. 15, 1998 to Tabler; U.S. Pat. No. 5,785,168 issued Jul. 28, 1998 to Beall, Jr.; U.S. Pat. No. 4,203,511 issued May 20, 1980 to Uhing; U.S. Pat. No. 3,164,104 issued Jan. 5, 1965 to Hunt; and U.S. Pat. No. 3,850,280 issued Nov. 26, 1974 to Ohrnell. The disclosures of each of these patents are incorporated by reference herein.

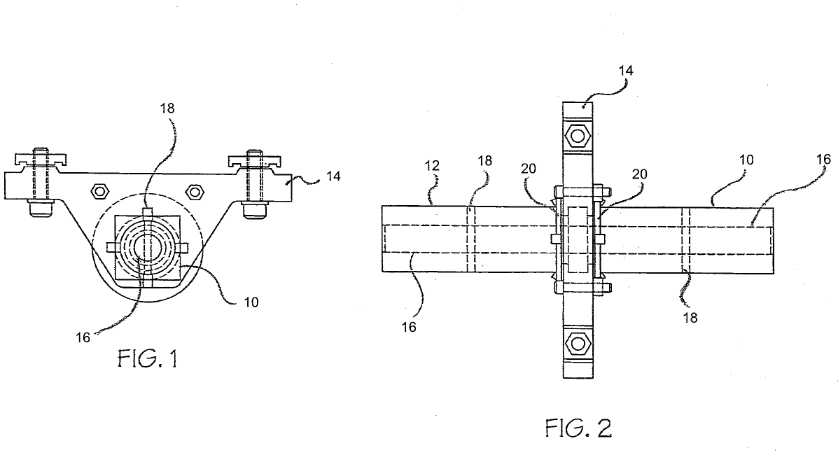

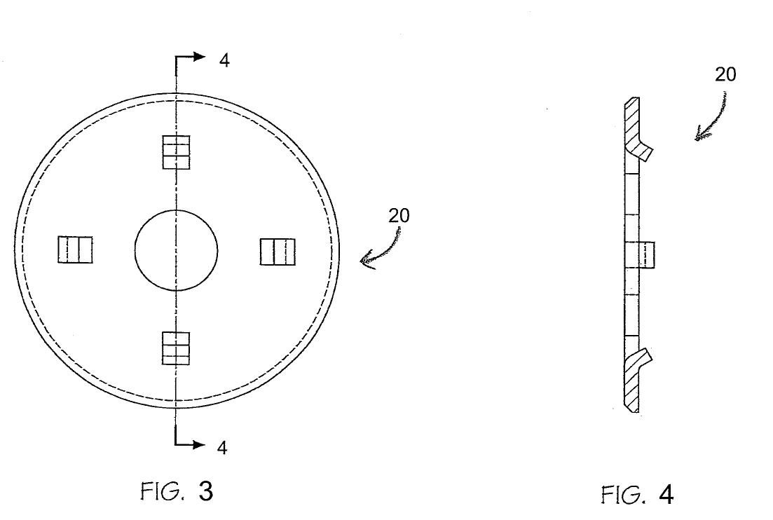

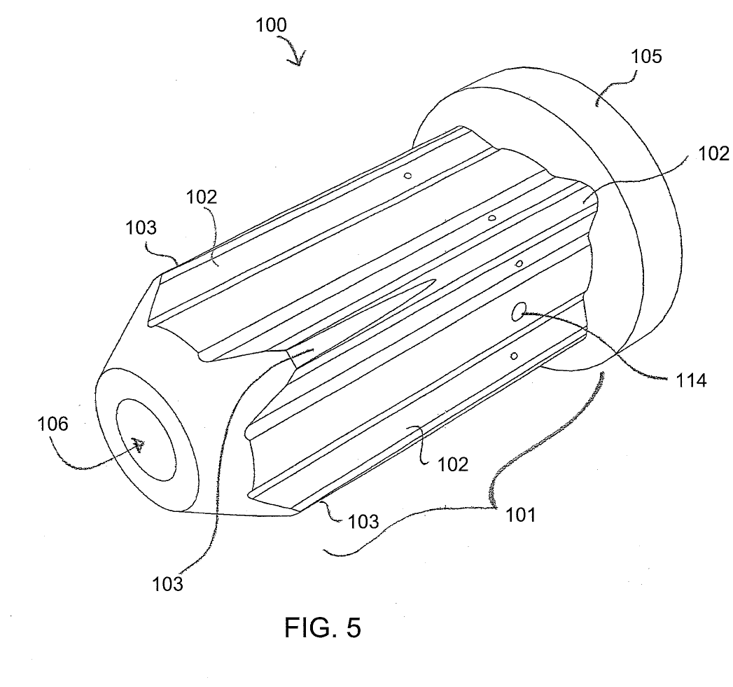

FIGS. 1 and 2 show an example of prior art drive tube couplings (10, 12), which comprise a substantially square bar configured to engage a drive tube. In some embodiments, prior art drive tube couplings (10, 12) may be made out of aluminum. Specifically, FIG. 2 shows an assembly comprising two prior art drive tube couplings (10, 12) connected to opposite sides of a bearing unit (14) using a prior art washer (20) on each side of bearing unit (14). FIGS. 3 and 4 show washer (20), which may be required to attach prior art drive tube couplings (10, 12) to bearing unit (14). As shown, bearing unit (14) includes a rotatable shaft (16) that is inserted through a central opening in bearing unit (14). In the illustrated embodiment, drive tube couplings (10, 12) are mounted onto shaft (16) on either side of bearing unit (14). At least one roll pin (18) is inserted through each drive tube coupling (10, 12) and shaft (16) to engage each drive tube coupling (10, 12) to shaft (16) such that drive tube couplings (10, 12) rotate unitarily with shaft (16).

FIG. 5 depicts an exemplary drive tube coupling (100) comprising an elongated portion (101) extending from a base portion (105). In this embodiment, elongated portion (101) extends substantially perpendicular to an inner surface of base portion (105), but this is not required. In the illustrated embodiment, base portion (105) comprises a substantially circular cross section. Of course, other suitable cross-sections for base portion may be used. As shown, elongated portion (101) of drive tube coupling (100) comprises a substantially square cross section with scalloped sides. In the illustrated embodiment, base portion (105) of drive tube coupling (100) is configured to replace the use of a washer, such as washer (20), that was required in prior art assemblies. In particular, embodiments of drive tube coupling (100) may be assembled together without washers, which may reduce labor and tooling costs. In this embodiment, elongated portion (101) comprises four ribs (102) equally spaced around the perimeter of elongated portion (101) and positioned on each corner of elongated portion (101). As shown, each rib (102) comprises a curved profile comprising angled or rounded sides along substantially the entire length of each rib (102) and a tapered portion (103) adjacent to the free end of each rib (102) (i.e. the end of each rib (102) distal to the end attached to base portion (105). Of course, other suitable configurations for elongated portion (101) that provide an adequate engagement between the drive tube coupling (100) and a corresponding drive tube may be used. Other suitable configurations may include changes to the shape, number, and arrangement of ribs (102), tapered portions (103) and/or the general cross-section of elongated portion (101).

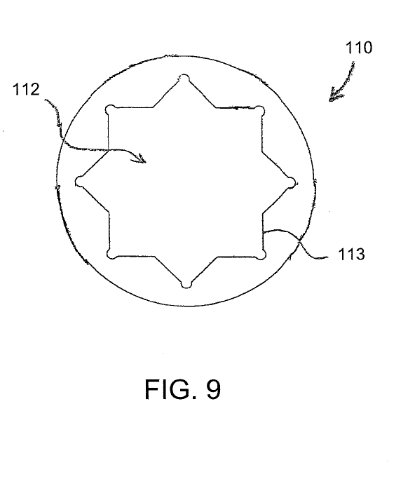

Elongated portion (101), and more specifically ribs (102), may be configured to correspond with and provide a friction fit between drive tube coupling (100) and a corresponding drive tube (110). An exemplary drive tube is shown in FIG. 7 (with drive tube coupling (100) inserted into drive tube (110)) and FIG. 9 (without drive tube coupling (100)). The relationship or fit between drive tube coupling (100) and drive tube (110) may help prevent drive tube coupling (100) from disengaging from drive tube (110) during the assembly process, which is described below.

In the illustrated embodiment, each rib (102) further comprises a detent (108) positioned on each side of the rib (102). As shown, each detent (108) comprises a semicircular protuberance extending from the surface of each rib (102). The number, size, placement, and shape of detents (108) may vary, provided the detents (108) are configured to enhance the friction fit between drive tube coupling (100) and drive tube (110). For example in alternate embodiments, fewer than all of the ribs may have detents or each rib may only have a single detent positioned on one side of the respective rib. In still further embodiments, each rib may comprise more than one detent on each side of one or more ribs. As shown, each detent (108) comprises a substantially similar shape, size, and location on the respective ribs (102), however this is not required. In the illustrated embodiment, detents (108) are arranged co-linearly around the perimeter of elongated portion (101), however this is not required. Detents (108) may be configured to add further friction between the two components when drive tube coupling (100) is inserted into drive tube (110). In still other alternate embodiments, the detents may be omitted entirely.

In this embodiment, drive tube coupling (100) further comprises an inner tube (104) that extends lengthwise through the center of drive tube coupling (100). Inner tube (104) may extend along the entire length of elongated portion (101) and through base portion (105). As shown, inner tube (104) is substantially cylindrical in shape and defines a central opening (106) extending through the center of drive tube coupling (100). In the illustrated embodiment, drive tube coupling (100) further comprises a roll pin hole (114) that extends substantially transverse to inner tube (104). Roll pin hole (114) is configured to receive a roll pin (not shown) when drive tube coupling (100) is assembled together with a bearing unit, such as bearing unit (510) described below.

FIG. 8 depicts drive tube coupling (100) positioned within a drive tube (110). Drive tube (110) is shown without drive tube coupling (100) in FIG. 9. As shown, drive tube (110) comprises an interior cavity (112) defined by an interior wall (113). In the illustrated embodiment, cavity (112) comprises a regular, sixteen-sided, generally star-shaped cross section. However, drive tube (110) may comprise any suitable shaped cross section as would be apparent to one of ordinary skill in the art in view of the teachings herein. Cavity (112) may be configured to receive elongated portion (101) of drive tube coupling (100). In this embodiment, each corner of cavity (112) defined by interior wall (113) are configured to receive and abut at least a portion of a respective rib (102). In addition, cavity (112) may be configured to correspond to the profile of elongated portion (101) such that ribs (102) and/or detents (108) result in an adequate friction fit between drive tube (110) and drive tube coupling (100). As a result of the engagement between drive tube (110) and drive tube coupling (100), the two components may be configured to rotate in unison with each other.

Embodiments of drive tube coupling (100) may be used to help assemble a series of drive tubes (110) during assembly of an overall conveyor system. For example, a first drive tube coupling (100) may be inserted into a first drive tube (110) and that complete assembly may then be attached to a preceding drive tube (110) that is already located in the conveyor system. The friction fit provided by ribs (102) and/or detents (108) may facilitate assembly by helping to ensure that the first drive tube coupling (100) remains engaged with and inside the first drive tube (110) during this assembly operation.

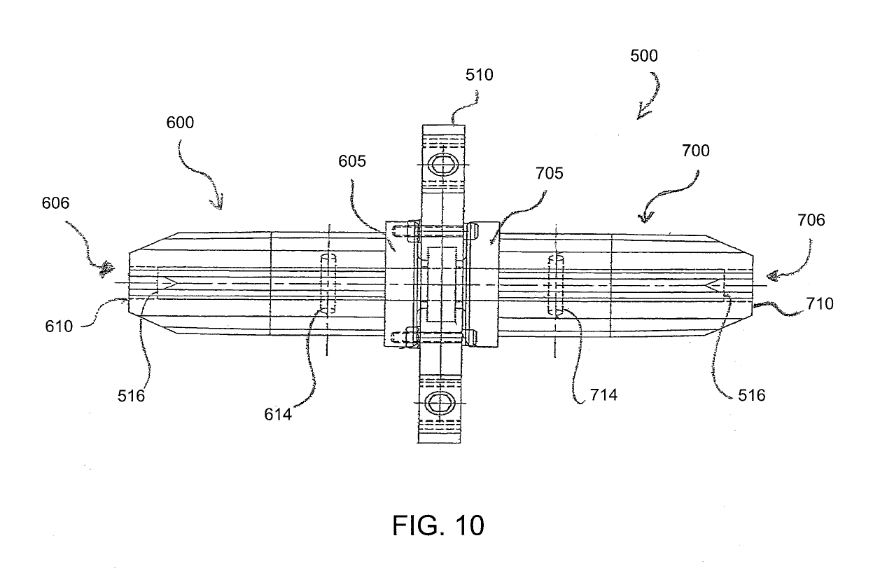

FIG. 10 depicts a drive tube coupling assembly (500) comprising a pair of drive tube couplings (600, 700) attached to a bearing unit (510). As shown, drive tube couplings (600, 700) are substantially identical to coupling (100) described above. Similar to bearing unit (14) described above, bearing unit (510) includes a rotatable shaft (516) inserted through a central opening in bearing unit (510). In the illustrated embodiment, drive tube couplings (600, 700) are mounted to shaft (516) on either side of bearing unit (510) by inserting shaft (516) through the central opening (606, 706) in each coupling (600, 700). In this embodiment, couplings (600, 700) are positioned along shaft such that base portions (605, 705) are substantially adjacent to bearing unit (510). Shaft (516) may be sized such that it provides a friction fit when inserted into the central opening (606, 706) of each coupling (600, 700), but this is not necessarily required. Each drive tube coupling (600, 700) may be engaged with shaft (516) by inserting at least one drive pin through a roll pin hole (614, 714) in each coupling (600, 700) and a corresponding opening in shaft (516). The roll pin may be configured to engage each coupling (600, 700) with shaft (516) such that drive tube couplings (600, 700) rotate unitarily with shaft (516), and, consequently, rotate unitarily with each other. In some embodiments the roll pin may be omitted from at least one coupling and any other suitable method or device for engaging at least one coupling with the shaft may be used, including but not limited to use of an adhesive, surface treatment or dimensioning the components to provide an adequate friction fit between each coupling and the shaft.

Drive tube coupling assembly (500) may be used to attach two drive tubes (not shown) together to form at least a portion of a conveyor system. As shown, the base portion (605, 705) of each coupling (600, 700) is adjacent to bearing unit (510). Contrary to the prior art coupling assembly shown in FIGS. 1 and 2, coupling assembly (500) does not require a washer (such as washer (20)) to attach couplings (600, 700) to bearing unit (510). Instead, the base portion (605, 705) of each coupling (600, 700) serves the same function as washer (20) in the prior art assembly. In the illustrated embodiment, each coupling (600, 700) extends substantially perpendicularly from opposite sides of bearing unit (510). A drive tube (not shown) may then be inserted onto the free end (610, 710) of each coupling (600, 700) to form a part of a conveyor system. Coupling assembly (500) may be assembled such that couplings (600, 700) can freely rotate relative to bearing unit (510). As a result, coupling (600) and a drive tube engaged therewith will rotate in unison with each other. Similarly, coupling (700) and a drive tube engaged therewith will rotate in unison with each other. Couplings (600, 700) may be configured to rotate in unison together.

In one embodiment, drive tube coupling (100) is molded from a high density urethane elastomer. Of course, drive tube coupling may comprise any suitable material configured to provide desired durability and strength depending on the particular application of coupling (100), including but not limited to other materials and resins suitable for use in casting or injection molding processes.

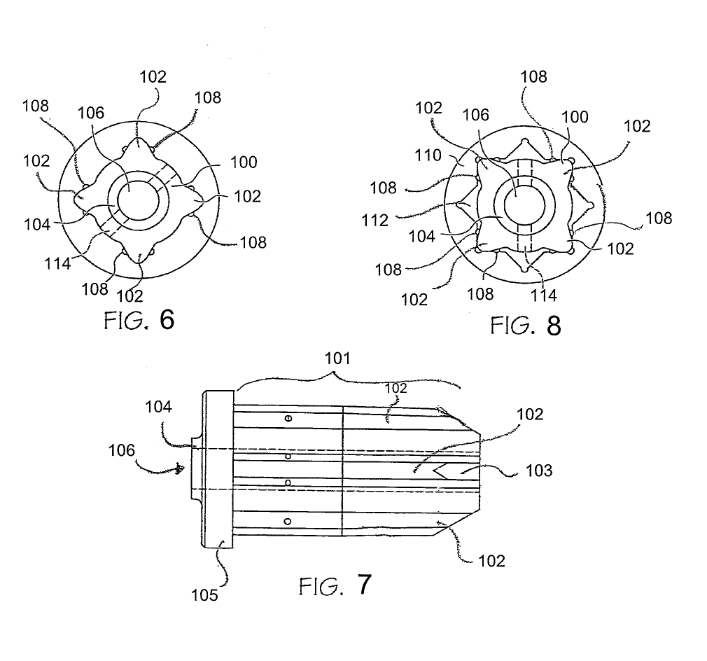

Drive tube coupling (100) may be molded as one piece in its finished shape, which may eliminate the need to machine the finished part. Molded embodiments of the drive tube coupling may have the cross sectional shape shown in FIG. 1 (i.e. substantially square), or the cross-sectional shape shown in FIGS. 5-8. Additionally, embodiments of drive tube coupling (100) comprising a molded elastomer may help reduce and/or eliminate noise caused by contact between drive tube coupling (100) and drive tube (110) when the conveyor system is in operation. In prior art embodiments, wherein both the drive tube coupling (10) and the drive tube comprise metal or some other similar material, contact between the drive tube coupling (10) and the drive tube produced noise during operation of the conveyor.

Having shown and described various versions in the present disclosure, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A coupling comprising:
(a) a base portion, wherein the base portion comprises a face, and
(b) an elongated portion, wherein the elongated portion extends from the face of the base portion at a first end, wherein the elongated portion further comprises at least one rib extending from the face of the base portion toward a distal end of the elongated portion.

2. The coupling of claim 1, wherein the elongated portion further comprises at least one detent positioned on at least one side of the at least one rib.

3. The coupling of claim 1, wherein the at least one rib further comprises a tapered portion on adjacent to the distal end of the elongated portion.

4. The coupling of claim 1, wherein the elongated portion comprises a substantially square cross-section with scalloped sides.

5. The coupling of claim 1, wherein the elongated portion further comprises an inner tube extending along at least a portion of the elongated portion, wherein a central longitudinal axis of the inner tube is aligned with a central longitudinal axis of the elongated portion.

6. The coupling of claim 5, wherein the coupling further comprises a length, wherein the inner tube extends through the elongated portion and the base portion along the entire length of the coupling.

7. The coupling of claim 5, wherein the coupling further comprises a roll pin hole comprising a longitudinal central axis, wherein the longitudinal central axis of the roll pin hole is substantially perpendicular to the longitudinal central axis of the inner tube.

8. The coupling of claim 1, wherein the elongated portion extends substantially perpendicularly to the face of the base portion.

9. The coupling of claim 1, wherein the elongated portion further comprises
(a) a perimeter, and
(b) a second rib,
(c) a third rib, and
(d) a fourth rib;
wherein the at least one rib, the second rib, the third rib, and the fourth rib are equally spaced and positioned around the perimeter of the elongated portion.

10. The coupling of claim 9, wherein the at least one rib, the second rib, the third rib, and the fourth rib each comprise a pair of detents associated with each respective rib, wherein one of the pair of detents is positioned on each side of a respective rib.

11. The coupling of claim 1, wherein the base portion and the elongated portion comprise a single integral member.

12. The coupling of claim 11, wherein the coupling comprises a high density urethane elastomer.

13. A coupling comprising:
(a) a base portion, wherein the base portion comprises a substantially circular cross-section; and
(b) an elongated portion, wherein the elongated portion is attached at a first end to the base portion, wherein the elongated portion comprises a substantially square cross-section with scalloped sides, wherein the elongated portion further comprises:
(i) a plurality of ribs extending along at least a section of the elongated portion, wherein the ribs are equally spaced around a perimeter of the elongated portion, and
(ii) a plurality of detents, wherein at least one detent is positioned on each of the plurality of ribs.

14. The coupling of claim 13, wherein at least one of the plurality of detents comprises a semi-circular protuberance extending from an outer surface of a respective one of the plurality of ribs.

15. The coupling of claim 13, wherein the plurality of detents are arranged co-linearly around the perimeter of the elongated portion.

16. The coupling of claim 13, wherein at least one of the plurality of detents comprises a different shape than at least one other one of the plurality of detents.

17. The coupling of claim 13, wherein the base portion is configured to serve as a washer when the coupling is assembled with a first drive tube and attached to a second drive tube.

18. An assembly comprising:
(a) a drive tube, wherein the drive tube comprises an inner cavity comprising a cross-section; and
(b) a drive tube coupler, wherein the drive tube coupler comprises
a base portion, and
(ii) an elongated portion, wherein the elongated portion comprises a plurality of ribs, wherein the plurality of ribs are operably sized and shaped to complement the cross-section of the inner cavity of the drive tube and provide and to provide a friction fit when the elongated portion of the drive tube coupler is inserted into the inner cavity of the drive tube, wherein the elongated portion further comprises at least one detent positioned on at least one of the plurality of ribs to enhance the friction fit between the drive tube coupler and the drive tube.

19. The assembly of claim 18, wherein the base portion of the drive tube coupler is integral with the elongated portion of the drive tube coupler.

20. The assembly of claim 18, wherein the elongated portion of the drive tube coupler comprises a substantially square cross-section with scalloped sides, wherein the inner cavity of the drive tube comprises a substantially star-shaped cross-section.
